(19) United States
(12) Patent Application Publication
(10) Pub. No.: US 2014/0108658 A1
(43) Pub. Date: Apr. 17, 2014

(54) COMPUTER-READABLE RECORDING MEDIUM STORING A RESOURCE MANAGEMENT PROGRAM, RESOURCE MANAGEMENT METHOD AND INFORMATION PROCESSING DEVICE

(71) Applicant: FUJITSU LIMITED, Kawasaki (JP)

(72) Inventors: Shinya Echigo, Yokohama (JP); Atsushi Shimano, Kawasaki (JP); Tomohiro Kawasaki, Yokohama (JP); Kento Shirakawa, Kawasaki (JP)

(73) Assignee: FUJITSU LIMITED, Kawasaki (JP)

(21) Appl. No.: 13/972,173

(22) Filed: Aug. 21, 2013

(30) Foreign Application Priority Data
Oct. 15, 2012 (JP) 2012-227850

(51) Int. Cl. H04L 12/911

(52) U.S. Cl. CPC H04L 47/70
USPC 709/226

(57) ABSTRACT

A first information processing device includes a determination section that determines whether or not there is an unused resource in the first information processing device by referring to information indicating whether or not there is an unused resource among resources ensured by each of a plurality of information processing devices sharing resources used in processing that is to be executed in response to a request, an specifying section that specifies, when there is not the unused resource in the first information processing device, another information processing device that has ensured an unused resource by referring to the information, a request section that requests for releasing the unused resource of the specified another information processing device, and an ensuring section that ensures an unused resource released in response to a request as a resource that the first information processing device is to use.

### CROSS-REFERENCE TO RELATED APPLICATION

This application is based upon and claims the benefit of priority of the prior Japanese Patent Application No. 2012-227850, filed on Oct. 15, 2012, the entire contents of which are incorporated herein by reference.

### FIELD

The embodiment discussed herein is related to a resource management program, a resource management method, and an information processing device.

### BACKGROUND

In an online system, in order to increase the processing capability of the entire system, a plurality of application servers is operated in parallel to increase simultaneous multiplicity of work processing.

In general, when application servers are operated in parallel, the application servers are caused to be equivalent to each other. The term “to be equivalent” herein means, for example, to execute the same work processing on the basis of the same setting. If the application servers are equivalent to each other, the same result is obtained even when a request from a client is processed by any one of the application servers. Also, it is advantageous that operational management of application servers may be simplified.

In particular, in an online system which operates a Web application, each application server continuously processes a series of operations from log-in to log-out, which are segmented on the basis of the concept of sessions.

Contents of work processing performed in each session might not be uniform. For example, in online shopping, the number of purchase items and a time spent for shopping differ among users. Such non-uniformity depending on users causes non-uniformity in processing contents between application servers which are arranged in parallel and equivalent.

Therefore, loads between application servers are equalized by performing load distribution on the basis of various indexes, such as the number of sessions, the number of processings, and so forth, and sharing sessions between the application servers.

On the other hand, in order to respond to a request from a client, a configuration in which each application server executes processing in a cooperative manner with another server (which will be hereinafter referred to as a “backend server”), such as a database server arranged at a backend has been employed. When each application server is cooperative with the backend server, a resource regarding the backend server is shared by the application servers. Examples of the resource regarding the backend server include a connection used for communication with the backend server. Normally, the number of such resources is limited. That is, there is an upper limit to the number of connections with the backend server. Therefore, how a limited number of sources are distributed to the applications becomes an issue.

As a method for distributing resources to application servers, there is a method in which, assuming the maximum load of each application server, resources of a number corresponding to an estimation on how many resources are to be used with the maximum load are distributed to each application server. Also, there is another method in which each application server receives, when using resource, resource corresponding to the number of resources which are to be used by the application server.

These relation techniques are disclosed for examples Japanese Laid-open Patent Publication No. 2002-41304, Japanese Laid-open Patent Publication No. 2006-209294, and Japanese Patent No. 3672236 describe the related techniques.

However, it is difficult to completely equalize processing contents of application servers. When non-uniformity in the processing contents occurs, the number of resources which the application servers use varies between the application servers.

Therefore, there might be cases where, when resources corresponding to the maximum load are distributed in advance, resource shortage occurs in an application server having a higher load than an estimated maximum load while one or more resources are left unused in a light-loaded application server.

Also, there might be cases where, when resources corresponding to the number of resources which are to be used are distributed as appropriate, resources up to the upper limit are first ensured by a high-loaded application and only an insufficient number of resources are left for an application server which is to use resources later.

### SUMMARY

According to an aspect of the invention, a first information processing device includes a determination section that determines whether or not there is an unused resource in the first information processing device by referring to information indicating whether or not there is an unused resource among resources ensured by each of a plurality of information processing devices sharing resources used in processing that is to be executed in response to a request, an specifying section that specifies, when there is not the unused resource in the first information processing device, another information processing device that has ensured an unused resource by referring to the information, a request section that requests for releasing the unused resource of the specified another information processing device, and an ensuring section that ensures an unused resource released in response to a request as a resource that the first information processing device is to use.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration example of an information processing system according to an embodiment;

FIG. 2 is a diagram illustrating a logic configuration of an information processing system according to an embodiment;

FIG. 3 is a diagram illustrating a hardware configuration example of an application server according to an embodiment;

FIG. 4 is a diagram illustrating a functional configuration example of an application server according to an embodiment;

FIG. 5 is a diagram illustrating a functional configuration example of a resource management section;

FIG. 6 is a flowchart illustrating an example procedure of processing executed by a resource management section in response to a resource discharge request;

FIG. 7 is a table illustrating a configuration example of a resource management table;

FIG. 8 is a table illustrating a configuration example of a resource state storage section;

FIG. 9 is a flowchart illustrating an example procedure of processing executed by a resource management section in response to an unused resource release request; and

FIG. 10 is a flowchart illustrating an example procedure of processing executed by a resource management section in response to a resource collection request.

### DESCRIPTION OF EMBODIMENT

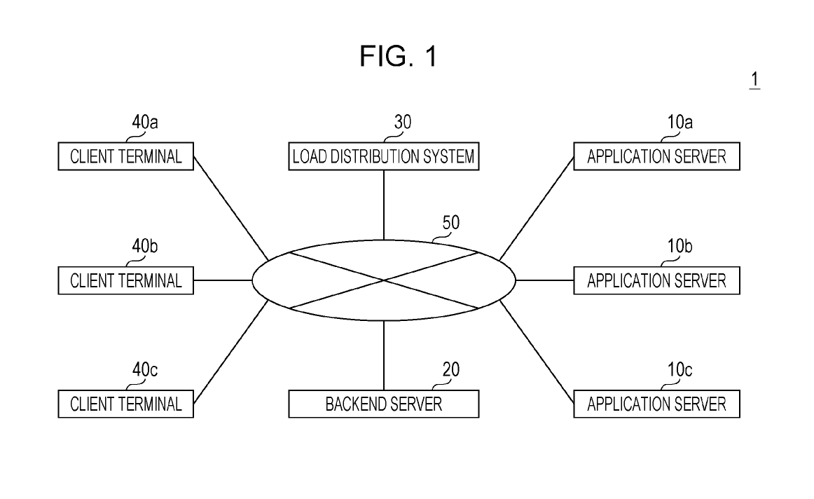

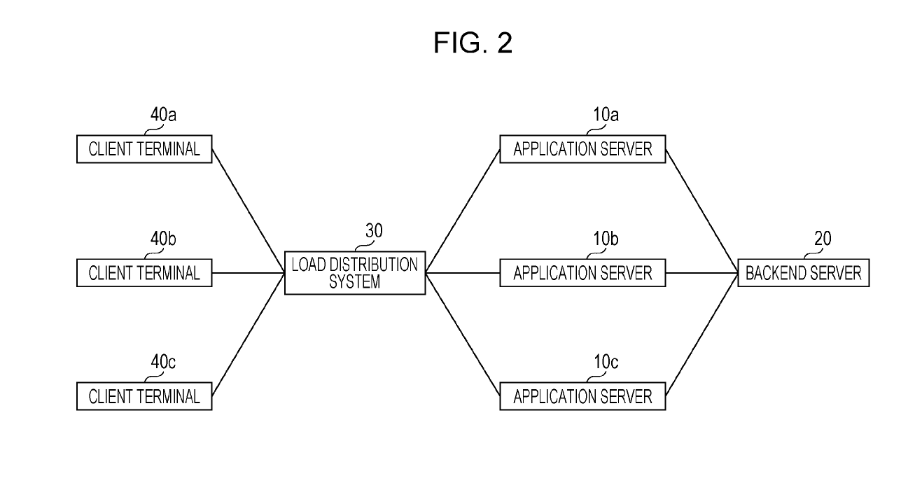

Hereinafter, an embodiment will be described with reference to the accompanying drawings. FIG. 1 is a diagram illustrating a configuration example of an information processing system according to this embodiment. In an information processing system 1 illustrated in FIG. 1, a plurality of client terminals 40, a load distribution system 30, a plurality of application servers 10, and a backend server 20 are provided to be communicable with one another via a network 50, such as, for example, a local area network (LAN), the Internet, and so forth. In FIG. 1, as examples of the application servers 10, application servers 10a, 10b, and 10c are illustrated. Also, as examples of the client terminals 40, client terminals 40a, 40b, and 40c are illustrated. The function of each component will be described with reference to FIG. 2.

FIG. 2 is a diagram illustrating a logic configuration of an information processing system according to this embodiment. In FIG. 2, the logical relationship among the components of the information processing system 1 is illustrated.

Each of the client terminals 40 is an information processing device, such as a personal computer (PC), a smart phone, a mobile phone, a tablet terminal, a personal digital assistance (PDA), and so forth, which transmits a processing request to the application servers 10.

The load distribution system 30 is an information processing device which selects a transfer destination of a processing request transmitted by a client device such that loads of the application servers 10 are approximately equalized and transfers the corresponding processing request to the selected one of the application servers 10.

Each of the application servers 10 is a computer which executes processing corresponding to the processing request transferred by the load distribution system 30. The application server 10 executes processing corresponding to the processing request in a cooperative manner with the backend server 20 as appropriate.

The backend server 20 is a computer or a computer system, such as a database server, a legacy system, and so forth, used by the application servers 10. Note that, in this embodiment, a connection between each of the application servers 10 and the backend server 20 is an example of a resource shared by the plurality of application servers 10. The connection between the application server 10 and the backend server 20 is a resource which is established for the application server 10 in order to communicate with the backend server 20. The number of connections which may be established at a time is limited, and an upper limit is set therefor.

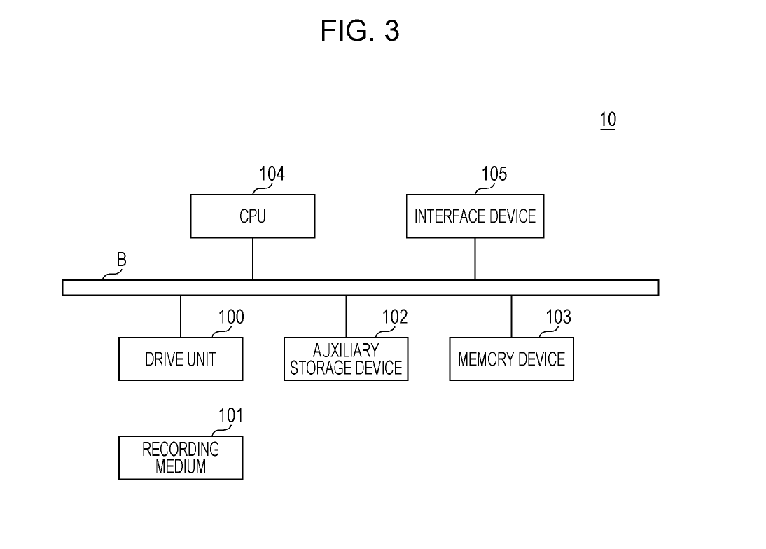

FIG. 3 is a diagram illustrating a hardware configuration example of an application server according to this embodiment. The application server 10 of FIG. 3 includes a driver unit 100, an auxiliary storage device 102, a memory device 103, a CPU 104, an interface device 105, and so forth.

A program which implements processing in the application servers 10 is provided by the recording medium 101. When the recording medium 101 in which the program is recorded is set in the driver unit 100, the program is installed in the auxiliary storage device 102 from the recording medium 101 via the driver unit 100. However, there might be cases where the program is not installed from the recording medium 101, and the program may be downloaded from another computer via a network. The auxiliary storage device 102 stores a file, data, and so forth, which are to be used, as well as the installed program.

When an instruction for running the program is made, the memory device 103 reads out the program from the auxiliary storage device 102 and stores it. The CPU 104 executes functions regarding the application servers 10 in accordance with the program stored in the memory device 103. The interface device 105 is employed as an interface used for providing connection to a network.

Note that examples of the recording medium 101 include a portable recording medium, such as a CD-ROM, a DVD disk, a USB memory, and so forth. Also, examples of the auxiliary storage device 102 include a hard disk drive (HDD), a flash memory, and so forth. Each of the recording medium 101 and the auxiliary storage device 102 corresponds to a computer-readable recording medium.

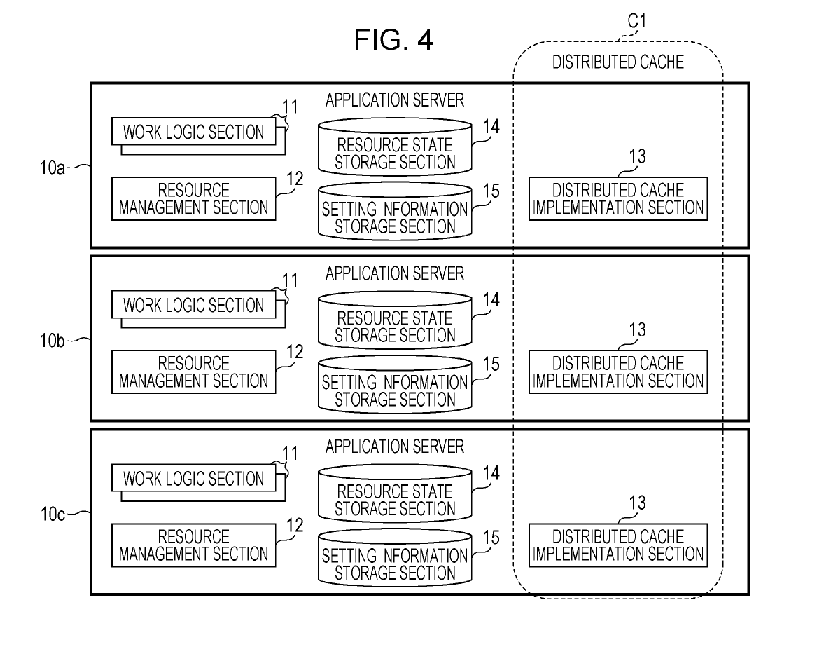

FIG. 4 is a diagram illustrating a functional configuration example of an application server according to this embodiment. As illustrated in FIG. 4, each of the application servers 10 includes one or more work logic sections 11, a resource management section 12, a distributed cache implementation section 13, and so forth. Each of the components is implemented by processing which one or more programs installed in each of the application servers 10 cause the CPU 104 of the corresponding one of the application servers 10 to execute. Also, each of the application servers 10 includes a resource state storage section 14 and a setting information storage section 15. The resource state storage section 14 and the setting information storage section 15 may be implemented, for example, using the auxiliary storage device 102 of each of the application servers 10. However, the resource state storage section 14 does not permanently stores information, and therefore, the resource state storage section 14 is preferably implemented using the memory device 103. The setting information storage section 15 may be implemented by a storage device connected to each of the application servers 10 via a network. Also, the setting information storage section 15 may be implemented for the application servers 10 in an integrated manner by a common storage device.

The work logic section 11 executes processing (for example, work logic and so forth) corresponding to a processing request transmitted from the client terminal 40. Each of the application servers 10 may include a plurality of work logic sections 11 such that each of the work logic sections 11 is provided for a processing content which is to be executed in accordance with the content or type of a request. The work logic section 11 may be implemented, for example, by processing which a web application program causes the CPU 104 to execute.

The resource management section 12 performs management of a resource which the work logic section 11 uses. For example, the resource management section 12 executes processing, such as ensuring or releasing a resource, and so forth. Also, when the number of resources ensured in the corresponding application server 10 is in shortage, the resource management section 12 requests the resource management section 12 of another one of the application servers 10 which has ensured an unused resource to release the resource, and ensures the released resource. The unused resource is a resource which is not being used. Even a resource which has been used in the past may be an unused resource if the resource is not currently being used.

Note that, in this embodiment, “to ensure a resource” does not mean “to immediately use a resource”. That is, for a resource, a state of “being ensured” does not correspond to a state of “being used”. The application server 10 which is to use a resource first ensures a resource. The application server 10 may use a resource ensured by itself. Therefore, for the resource, there is a state of being ensured but not being used. In this embodiment, for a resource in such a state, giving and receiving between the application servers 10 is enabled.

A resource in this embodiment corresponds to a connection with the backend server 20, and therefore, ensuring a resource corresponds to establishing a connection with the backend server 20. Using a resource corresponds to executing communication with the backend server 20. A connection which is established and is not being used for communication corresponds to a resource which is ensured but is not being used.

The distributed cache implementation section 13 of each of the application servers 10 logically and virtually implements a distributed cache C1 extending over the plurality of application servers 10. The distributed cache C1 is a related art technology used for implementing a cache using a plurality of computers. In this embodiment, the distributed cache C1 is used as a component which enables the plurality of application servers 10 to share information. The shared information is a resource management table 16, which will be described later. The resource management table 16 is a table which stores information indicating a use status of a resource and is provided for each of the application servers 10.

The resource state storage section 14 stores information indicating the state of a resource ensured in the corresponding application server 10, that is, information indicating whether the resource is being used or unused.

The setting information storage section 15 stores setting information regarding cooperation with the backend server 20. In this embodiment, a value (which will be hereinafter referred to as an “upper limit”) indicating the upper limit of the number of connections with the backend server 20 is stored in the setting information storage section 15. The upper limit is the upper limit to the number of the application servers 10. That is, the total number of connections of the plurality of application servers 10 with the backend server 20 is not allowed to exceed the upper limit.

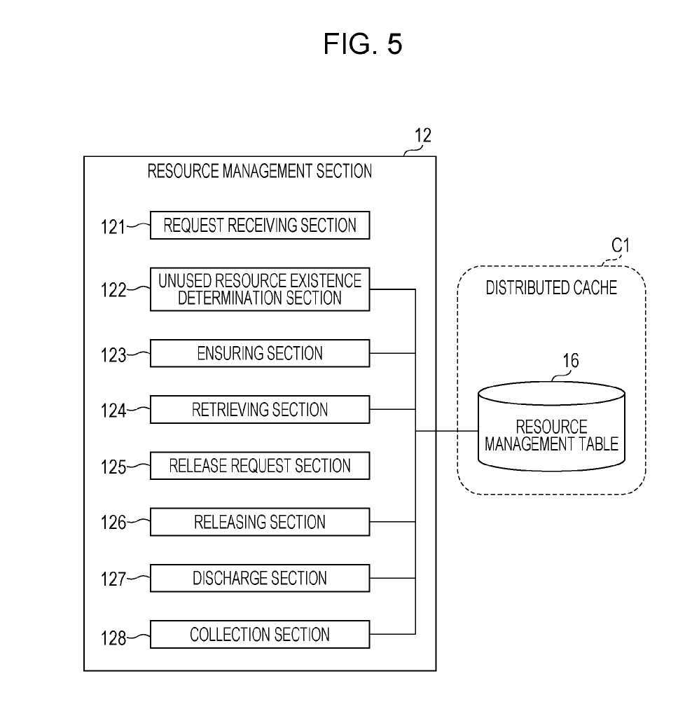

FIG. 5 is a diagram illustrating a functional configuration example of a resource management section. In FIG. 5, the resource management section 12 includes a request receiving section 121, an unused resource existence determination section 122, an ensuring section 123, a retrieving section 124, a release request section 125, a releasing section 126, a discharge section 127, a collection section 128, and so forth.

The request receiving section 121 receives a discharge request for discharging a resource transmitted from the work logic section 11. For example, when communication with the backend server 20 is started, the work logic section 11 transmits a request for discharge of a resource, more specifically, a request for use of a connection with the backend server 20 to the request receiving section 121. The request receiving section 121 receives a collection request for collecting a resource transmitted from the work logic section 11. For example, when communication with the backend server 20 is ended, the work logic section 11 transmits a request for collecting the corresponding resource to the request receiving section 121.

The unused resource existence determination section 122 determines whether or not there is an unused resource among resources ensured in the corresponding application server 10. The determination is performed by referring to the resource management table 16 stored in the distributed cache C1. The ensuring section 123 executes resource ensuring. That is, the ensuring section 123 establishes a connection with the backend server 20. The retrieving section 124 retrieves another one of the application servers 10 which has ensured an unused resource. Retrieving is conducted by referring to the resource management table 16. The release request section 125 transmits a release request for releasing an unused resource to the another one of the application servers 10 which has been retrieved by the retrieving section 124. The releasing section 126 releases an unused resource in response to a release request for releasing an unused resource transmitted from the another application server 10. Releasing a resource refers to canceling a state where a resource is ensured. In this embodiment, releasing a resource corresponds to disconnecting an established connection with the backend server 20. The discharge section 127 discharges an ensured resource to a discharge request source in response to a discharge request for discharging a resource. Discharging a resource refers to permitting use of an ensured resource. For example, in discharging a resource, an identifier (which will be hereinafter referred to as a “resource ID”) used for using the resource, and so forth, is returned to the discharge request source.

In response to a collection request for collecting a resource, the collection section 128 collects the corresponding resource. The collected resource serves as an unused resource and may be discharged in response to a new discharge request.

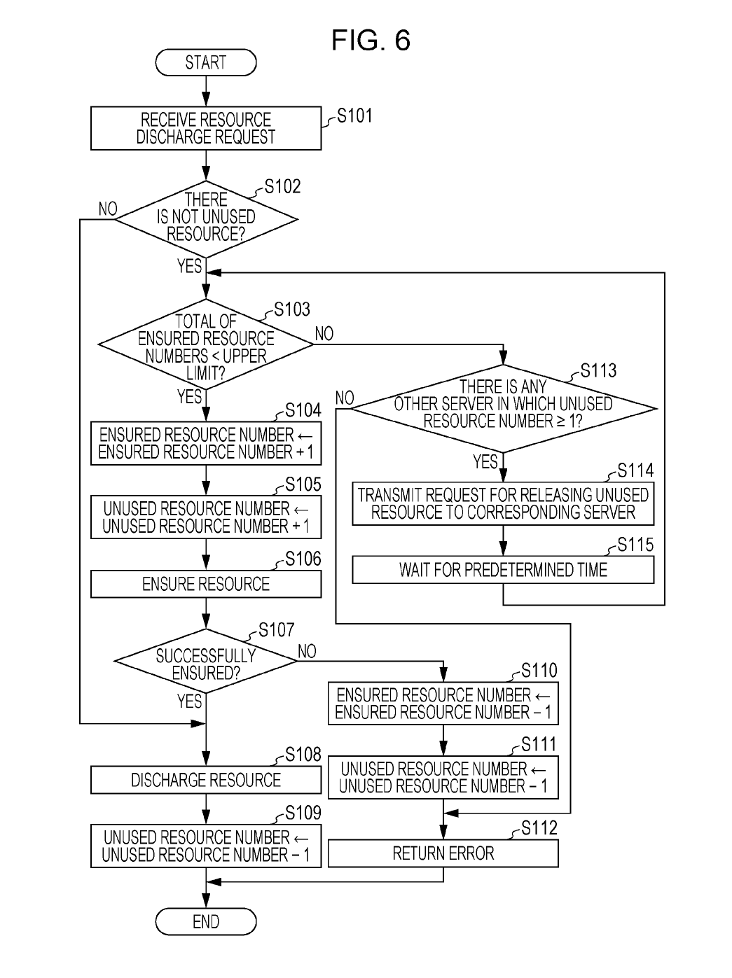

A procedure of processing executed by the resource management section 12 of the application server 10 will be hereinafter described. FIG. 6 is a flowchart illustrating an example procedure of processing executed by a resource management section in response to a resource discharge request.

In Step S101, the request receiving section 121 receives a discharge request for discharging a resource transmitted from the work logic section 11. Subsequently, the unused resource existence determination section 122 determines, for the corresponding application server 10, whether or not there is a resource which is ensured and is not being used by referring to the resource management table 16 (S102).

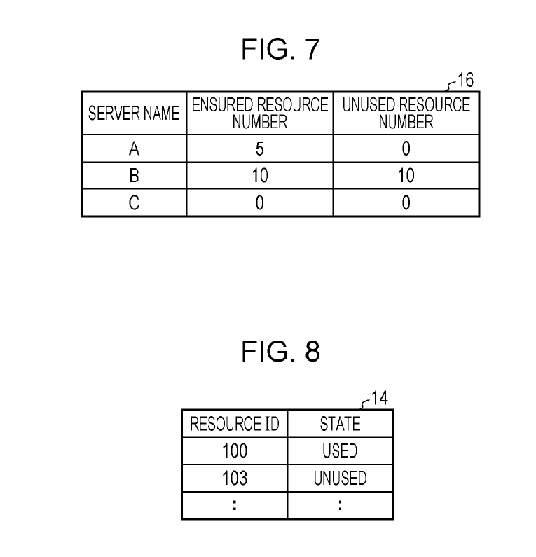

FIG. 7 is a table illustrating a configuration example of a resource management table. In FIG. 7, the resource management table 16 stores a server name, an ensured resource number, an unused resource number, and so forth for each of the application servers 10. The server name is an identification name of each of the application servers 10. In this embodiment, “A”, “B”, and “C” are the respective server names of the application servers 10a, 10b, and 10c. The ensured resource number is the number of ensured resources. The unused resource number is the number of unused resources. Therefore, (the ensured resource number−the unused resource number) is the number of used resources.

The resource management table 16 is provided in the distributed cache C1. Therefore, the application servers 10 refer to the resource management table 16 which is logically and virtually shared. A reason why it is described that the resource management table 16 is “logically and virtually shared” is that a device accessing the resource management table 16 does not recognize a physical location of the resource management table 16 and it seems to the device that a single resource management table 16 is provided for the plurality of application servers 10.

Note that how information stored in the resource management table 16 is physically arranged depends on how the distributed cache implementation section 13 is implemented. For example, as for implementation of the distributed cache C1, the following implementation examples are possible.

In a first implementation example, the whole resource management table 16 is stored in the memory device 103 of each of the application servers 10. In this case, the distributed cache implementation section 13 of each of the application servers 10 executes processing of reflecting, to its own resource management table 16, an update of the resource management table 16 performed in any one of the other application servers 10.

In a second implementation example, only information regarding the application server 10 is stored in the memory device 103 of each of the application servers 10. That is, each line illustrated in FIG. 7 is distributed to and stored in the memory device 103 of each of the application servers 10. In this case, the distributed cache implementation section 13 of each of the application servers 10 executes processing of causing information stored in another one of the application servers 10 to look as if it were stored in the application server 10.

Note that the distributed cache C1 may be implemented by an implementation example other than the above-described implementation examples.

In Step S102, if the corresponding application server 10 is the application server 10a or the application server 10c, the unused resource number is 0. Therefore, in this case, in Step S102, it is determined that there is no unused resource.

If there is no unused resource (YES in S102), the ensuring section 123 determines whether or not the total of the ensured resource numbers of the application servers 10 stored in the resource management table 16 is less than the upper limit stored in the setting information storage section 15 (S103). That is, whether or not a new resource is ensured is determined. In the example of FIG. 7, the total of the ensured resource numbers is 5+10=15. Thus, for example, when the upper limit is 16 or more, in Step S103, it is determine that the total of the ensured resource numbers is less than the upper limit.

If the total of the ensured resource numbers is less than the upper limit (YES in S103), the ensuring section 123 adds 1 to each of the ensured resource number and the unused resource number for the corresponding application server 10 in the resource management table 16 (S104 and S105). In order to reflect a the number of resources which are to be ensured in Step S106 which will be described later to the ensured resource number, 1 is added to the ensured resource number. Also, because a resource which is to be ensured is not used at the time when it is ensured, in order to reflect the above-described state, 1 is added to the unused resource number.

Subsequently, the ensuring section 123 ensures a new resource (S106). In this embodiment, a new connection with the backend server 20 is established. The ensuring section 123 stores the ID and state of the ensured resource in the resource state storage section 14 in the corresponding application server 10.

FIG. 8 is a table illustrating a configuration example of a resource state storage section. In FIG. 8, the resource state storage section 14 stores a resource ID and a state for each resource ensured in the corresponding application server 10. The state is represented by “used” or “unused”. In Step S106, the ensured resource is not used, and thus, “unused” is stored for the state.

If a new resource is successfully ensured (YES in S107), the discharge section 127 discharges the newly ensured resource to the work logic section 11 serving as a discharge request source (S108). The discharge section 127 updates the state of the discharged resource stored in the resource state storage section 14 from “unused” to “used”. That is, in this embodiment, the state where the resource is discharged and the use state are equivalent to each other. Also, the state where the resource is collected and the unused state are equivalent to each other.

Subsequently, the discharge section 127 subtracts 1 from the unused resource number for the corresponding application server 10 (S109). Because, when a resource is discharged to the work logic section 11, the resource is to be used, 1 is subtracted from the unused resource number.

In Step S106, if, for some reason, ensuring of a resource fails (NO in S107), the ensuring section 123 subtracts 1 from each of the ensured resource number and the unused resource number for the corresponding application server 10 in the resource management table 16 (S110 and S111). In order to cancel a number added in Step 104 and Step 105 on the assumption that a resource be successfully ensured, 1 is subtracted from each of the ensured resource number and the unused resource number.

Subsequently, the discharge section 127 returns an error to the work logic section 11 serving as a discharge request source (S112). However, S106 and the subsequent steps may be executed again after waiting for a predetermined time.

On the other hand, in Step S102, if there is an unused resource (YES in S102), Steps S103 to S107 are not executed, and Step S108 and the subsequent steps are executed. In Step S108, one of the unused resources is returned to the work logic section 11 serving as a discharge request source. The resource ID of the unused resource may be specified by referring to the resource state storage section 14.

For example, if the corresponding application server 10 is the application server 10b, as illustrated in FIG. 7, the unused resource number is 10. Thus, in this case, following Step S102, Steps S108 and S109 are executed.

In Step S103, if the total of the ensured resource numbers of the application servers 10 has reached to the upper limit (NO in S103), the retrieving section 124 retrieves another one of the application servers 10 having an unused resource number of 1 or more by referring to the resource management table 16 (S113). For example, in FIG. 7, the unused resource number of the application server 10b is 10. Then, assume that the corresponding application server 10 is the application server 10a and the upper limit stored in the setting information storage section 15 is 15, which is the same as the total of the ensured resource numbers. In this case, in Step S113, as another one of the application servers 10 having an unused resource number of 1 or more, the application server 10b is retrieved.

If the another application server 10 is retrieved (YES in S113), the release request section 125 transmits a release request for releasing an unused resource to the resource management section 12 of the another application server 10 (S114). Subsequently, after the release request is transmitted, the resource management section 12 of the corresponding application server 10 (that is, the application server 10 which has transmitted the release request) waits for a predetermined time (S115). Subsequently, Step S103 and the subsequent steps are repeated. That is, expecting that the unused resource is released in response to the release request or that an unused resource is coincidentally released in any one of the application servers 10 within the predetermined time, Step S103 and the subsequent steps are executed again. If an unused resource is released while waiting for the predetermined time, Step S104 and the subsequent steps are executed.

On the other hand, if there is not another application server 10 having an unused resource number of 1 or more (NO in S113), Step S112 is executed. However, also in this case, after waiting for the predetermined time, Step S103 and the subsequent steps may be repeated. This is because another application server 10 having an unused resource number of 1 or more might occur after waiting for the predetermined time.

Note that, in the resource management table 16 of FIG. 7, an example where the unused resource number is stored for each of the application servers 10 is illustrated. However, in Step S113, whether or not there is an unused resource may be specified. Therefore, there may be cases where the number of unused resources is not stored in the resource management table 16, and information indicating whether or not there is an unused resource may be stored therein. The unused resource number may be an example of the information indicating whether or not there is an unused resource.

Subsequently, processing executed by the resource management section 12 of the application server 10 which has received a release request for releasing an unused resource transmitted in Step S114 will be described.

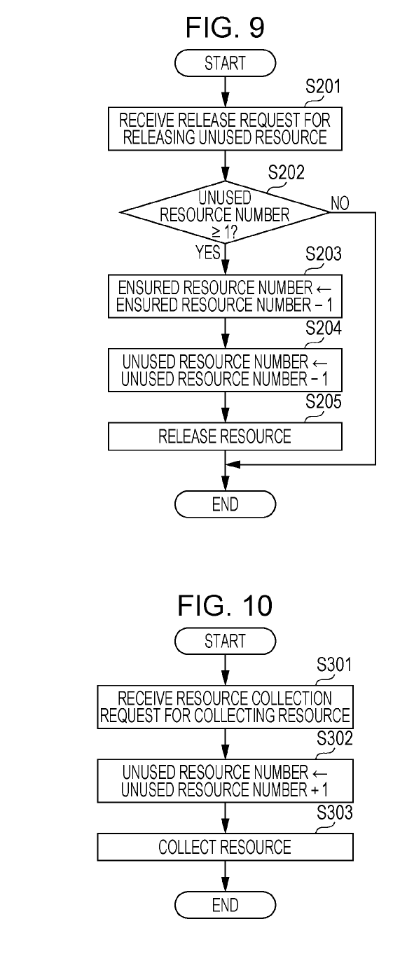

FIG. 9 is a flowchart illustrating an example procedure of processing executed by a resource management section in response to an unused resource release request.

In the application server 10, when a release request for releasing an unused resource transmitted from another application server 10 (S201) is received, the releasing section 126 confirms whether or not the unused resource number of the application server 10 is 1 or more by referring to the resource management table 16 (S202). For example, when a release request for releasing an unused resource is transmitted to the application server 10b from the application server 10a, the corresponding application server 10 to that described in FIG. 9 is the application server 10b.

If the unused resource number is 1 or more (YES in S202), the releasing section 126 subtracts 1 from each of the ensured resource number and the unused resource number for the corresponding application server 10 in the resource management table 16 (S203 and S204). Subsequently, the releasing section 126 releases one of the unused resources (S205). In this embodiment, one of the connections with the backend server 20 is disconnected. Which one of the resources is an unused resource in the application server 10 may be specified by referring to the resource state storage section 14 of the corresponding application server 10. The releasing section 126 deletes the record corresponding to the resource from the resource state storage section 14, as the resource is released. Note that subtraction performed in Steps S203 and S204 corresponds to releasing of an unused resource performed in Step S205.

The unused resource is released in response to the release request, and thus, the total of the ensured resource numbers becomes less than the upper limit. Therefore, in the application server 10 serving as a release request source, the probability that a new resource is ensured increases. That is, the application server 10 which has requested for releasing of an unused resource may receive a resource corresponding one allocated for another one of the application servers 10 which has released an unused resource.

On the other hand, if there is no unused resource (NO in S202), Step S203 and the subsequent steps are not executed.

Subsequently, a procedure of processing executed by the resource management section 12 when a collection request for collecting a resource transmitted from the work logic section 11 serving as a resource discharge source is received.

FIG. 10 is a flowchart illustrating an example procedure of processing executed by a resource management section in response to a resource collection request.

In Step S301, the request receiving section 121 receives a collection request for collecting a resource transmitted from the work logic section 11. For example, in the collection request, the resource ID of a collection target resource is specified. Subsequently, the collection section 128 adds 1 to the unused resource number for the corresponding application server 10 in the resource management table 16 (S302). This is because the number of unused resources is increased by collection of a resource. Subsequently, the collection section 128 collects the collection target resource (S303). Specifically, in the resource state storage section 14 of the corresponding application server 10, the state corresponding to the resource ID of the collection target resource is updated from “used” to “unused”.

As described above, according to this embodiment, in the case where resource shortage occurs in one of the application servers 10, that is, in the case where a resource is to be ensured, if the total of the ensured resource numbers has reached the upper limit, an unused resource of another one of the application servers 10 is released. The application server 10 in which resource shortage has occurred may ensure the released resource. That is, giving and receiving of the unused resource may be implemented between the application servers 10. Therefore, the flexibility of resource distribution to the application servers 10 may be increased. As a result, for example, for processing in accordance with a request transmitted from the client terminal 40, even when non-uniformity has occurred between the application servers 10 and the number of resources which the application servers 10 are to use varies between the application servers 10, the probability that each of the application servers 10 may perform stable response may be increased.

Also, the cases where each of the application servers 10 is caused to ensure a great number of resources on the assumption that the maximum load may be reduced.

In the resource management table 16 shared by the application servers 10, the use status of each of the resources of the application servers 10 is stored. Therefore, one of the application servers 10 in which resource shortage has occurred may quickly retrieve another one of the application servers 10 in which an unused resource is ensured by referring to the resource management table 16.

The ensured resource number for each of the application servers 10 is stored in the resource management table 16, and thus, each of the application servers 10 may know the total of the ensured resource numbers. Therefore, each of the application servers 10 may quickly determine whether or not there is a new resource by comparing the total to the upper limit. Note that there may be cases where the ensured resource number is not stored in the resource management table 16 shared by the application servers 10. In this case, when ensuring of a resource fails, each of the application servers 10 executes heavy load processing, such as detection of resource shortage. According to this embodiment, however, such processing is not executed.

In this embodiment, it is less likely that the setting value depending on the number of the application servers 10 is given to each of the application servers 10. Thus, the cost of system management may be reduced. Examples of the setting value depending on the number of the application servers 10 include a quota set when the ensured resource number is allocated to each of the application servers 10 in advance. For example, the quota is obtained by an operation of dividing the upper limit of the number of resources by the number of the application servers 10. Thus, the quota is dependent on the number of the application servers 10.

In this embodiment, control is not intensively performed by a specific server but each of the application servers 10 actively executes processing. Therefore, a case where a specific server is out of control because of a wrong operation, and so forth is less likely to occur.

Note that there may be cases where the resource management table 16 in this embodiment is not implemented using the distributed cache C1. The resource management table 16 may be stored in a storage device which is physically accessible in common by application servers. However, the distributed cache C1 is an established technology and has high accessibility. Therefore, by using the distributed cache C1, the operability of the resource management table 16 may be increased.

Also, there may be cases where a resource is not a connection. For example, a resource may be a storage device shared by the plurality of application servers 10. In this case, each of the application servers 10 may release a storage region which is ensured and is not being used for the other ones of the application servers 10.

Furthermore, a resource may be one of a hardware resource and a software resource.

Note that, in this embodiment, the application server 10 is an example of the computer or the information processing device. The unused resource existence determination section 122 is an example of the determination section. The retrieving section 124 is an example of the specifying section. The release request section 125 is an example of the request section.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A computer-readable recording medium storing therein a resource management program that causes a first computer to execute a procedure, the procedure comprising:
processing of determining whether or not there is an unused resource in the first computer by referring to information indicating whether or not there is an unused resource among resources ensured by each of a plurality of another computers sharing resources used in processing that is to be executed in response to a request,
processing of specifying, when there is not the unused resource in the first computer, another computer that has ensured an unused resource by referring to the information,
processing of requesting for releasing the unused resource of the specified another computer, and
processing of ensuring an unused resource released in response to a request as a resource that the first computer is to use.

2. The computer-readable recording medium according to claim 1,
wherein, in the processing of specifying another computer, when the total of ensured resource numbers of the plurality of computers sharing the resources has reached un upper limit of the number of the resources, and also when there is not the unused resource in the first computer, another computer that has ensured an unused resource is specified.

3. The computer-readable recording medium according to claim 1,
wherein, in response to the request for releasing the unused resource transmitted from another one of the computers sharing the resources, the first computer is caused to execute processing of releasing the unused resource among the resources ensured by the computers.

4. A resource management method comprising:
processing of determining whether or not there is an unused resource in a first computer by referring to information indicating whether or not there is an unused resource among resources ensured by each of a plurality of computers sharing resources used in processing that is to be executed in response to a request;
processing of specifying, when there is not the unused resource in the first computer, another computer that has ensured an unused resource by referring to the information;
processing of requesting for releasing the unused resource of the specified another computer; and
processing of ensuring an unused resource released in response to a request as a resource that the first computer is to use.

5. The resource management method to claim 4,
wherein, in the processing of specifying another computer, when the total of ensured resource numbers of the plurality of computers sharing the resources has reached un upper limit of the number of the resources, and also when there is not the unused resource in the first computer, another computer that has ensured an unused resource is specified.

6. The computer-readable, non-transitory medium according to claim 4,
wherein, in response to the request for releasing the unused resource transmitted from another one of the computers sharing the resources, the first computer is caused to execute processing of releasing the unused resource among the resources ensured by the computers.

7. A first information processing device comprising:
a determination section that determines whether or not there is an unused resource in the first information processing device by referring to information indicating whether or not there is an unused resource among resources ensured by each of a plurality of information processing devices sharing resources used in processing that is to be executed in response to a request;
an specifying section that specifies, when there is not the unused resource in the first information processing device, another information processing device that has ensured an unused resource by referring to the information;
a request section that requests for releasing the unused resource of the specified another information processing device; and
an ensuring section that ensures an unused resource released in response to a request as a resource that the first information processing device is to use.

8. The first information processing according to claim 7,
wherein the specifying section specifies, when the total of ensured resource numbers of the plurality of information processing devices sharing the resources has reached un upper limit of the number of the resources, and also when there is not the unused resource in the first information processing device, another information processing device that has ensured an unused resource.

9. The first information processing according to claim 7, further comprising:
a releasing section that releases, in response to the request for releasing the unused resource from another one of the information processing devices sharing the resources, the unused resource among the resources ensured by the information processing devices.
